(19) United States
(12) Patent Application Publication
(10) Pub. No.: US 2026/0097746 A1
(43) Pub. Date: Apr. 9, 2026

(54) VEHICLE CONTROL DEVICE

(71) Applicant: TOYOTA JIDOSHA KABUSHIKI KAISHA, Toyota-shi (JP)

(72) Inventor: Yota KATO, Numazu-shi (JP)

(73) Assignee: TOYOTA JIDOSHA KABUSHIKI KAISHA, Toyota-shi (JP)

(21) Appl. No.: 19/270,824

(22) Filed: Jul. 16, 2025

(30) Foreign Application Priority Data
Oct. 3, 2024 (JP) 2024-174043

(51) Int. Cl. B60T 7/22

(52) U.S. Cl. CPC B60T 7/22; B60T 2201/022; B60T 2210/32; B60T 2250/04

(57) ABSTRACT

A vehicle control device executes deceleration control for automatically decelerating a vehicle for an object that is present in the direction of travel of the vehicle. The vehicle control device executes the deceleration control such that the start timing of the deceleration control and a deceleration-related value that changes due to the deceleration control satisfy a restriction condition. When a specific condition that a traffic congestion or a traffic congestion-causing event that causes the traffic congestion has occurred within a predetermined distance from the vehicle in the direction of travel is satisfied, the vehicle control device eases the restriction condition compared to when the specific condition is not satisfied.

### CROSS-REFERENCE TO RELATED APPLICATION

This application claims priority to Japanese Patent Application No. 2024-174043 filed on Oct. 3, 2024. The disclosure of the above-identified application, including the specification, drawings, and claims, is incorporated by reference herein in its entirety.

### BACKGROUND

### 1. Technical Field

The present disclosure relates to vehicle control devices configured to execute deceleration control for automatically decelerating a vehicle for an object that is present in the direction of travel of the vehicle.

### 2. Description of Related Art

There is known a vehicle control device configured to execute deceleration control for automatically decelerating a vehicle for an object that is present in the direction of travel of the vehicle. For example, a vehicle control device described in Japanese Unexamined Patent Application Publication No. 2020-166392 (JP 2020-166392 A) (hereinafter referred to as “conventional device”) executes the deceleration control when it recognizes the last vehicle in a traffic congestion.

Specifically, when the conventional device recognizes the last vehicle in a traffic congestion based on traffic congestion information received from the outside of the vehicle, the conventional device executes the deceleration control even when an autonomous sensor mounted on the vehicle does not recognize the last vehicle in the traffic congestion.

### SUMMARY

Restriction conditions for the deceleration control are set in order to improve the ride comfort of vehicle occupants. The deceleration control is executed so as to satisfy the restriction conditions. The restriction conditions are conditions related to the start timing of the deceleration control and deceleration-related values (such as deceleration and jerk of deceleration) that change due to the deceleration control.

When a traffic congestion or an event that causes a traffic congestion occurs in the direction of travel of a vehicle, there is an increased possibility that surrounding vehicles around the vehicle may show unexpected behaviors. The unexpected behaviors of the surrounding vehicles are, for example, sudden deceleration of the preceding vehicle and sudden cutting-in of an adjacent vehicle.

If the deceleration control that satisfies the above restriction conditions is executed when a surrounding vehicle shows such an unexpected behavior, the vehicle may not be decelerated sufficiently, which may increase the risk of collision.

The present disclosure was made to address the above issue. In other words, one object of the present disclosure is to provide a vehicle control device that can reduce the possibility that the risk of collision may increase due to insufficient deceleration of a vehicle when there is an increased possibility that a surrounding vehicle may show an unexpected behavior.

A vehicle control device of the present disclosure (hereinafter referred to as “device of the present disclosure”) is configured to execute deceleration control for automatically decelerating a vehicle for an object that is present in the direction of travel of the vehicle (steps 400 to 495).

The vehicle control device is configured to
execute the deceleration control such that a start timing of the deceleration control and a deceleration-related value that changes due to the deceleration control satisfy a restriction condition (step 415, steps 425 to 445, steps 460 to 490), and
when a specific condition is satisfied (“Yes” in step 325, “Yes” in step 345, “Yes” in step 355, “Yes” in step 365, “Yes” in step 370), ease the restriction condition (step 330, step 335) compared to when the specific condition is not satisfied (step 375, step 380). The specific condition is a condition that a traffic congestion or a traffic congestion-causing event has occurred within a predetermined distance from the vehicle in the direction of travel. The traffic congestion-causing event is an event that causes the traffic congestion.

When the specific condition is satisfied, the restriction condition is eased compared to when the specific condition is not satisfied. Therefore, it is possible to increase the possibility that the deceleration control may sufficiently decelerate the vehicle even if a surrounding vehicle shows an unexpected behavior. This reduces the possibility that the risk of collision between a surrounding vehicle and the vehicle may increase when the surrounding vehicle shows an unexpected behavior.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic system configuration diagram of a vehicle control device according to an embodiment of the present disclosure;

FIG. 2 is an illustration of an operation example of the vehicle control device according to the embodiment of the present disclosure;

FIG. 3 is a flowchart of a specific condition determination routine executed by a CPU of an ECU shown in FIG. 1; and

FIG. 4 is a flowchart of a deceleration control routine executed by the CPU of the ECU shown in FIG. 1.

### DETAILED DESCRIPTION OF EMBODIMENTS

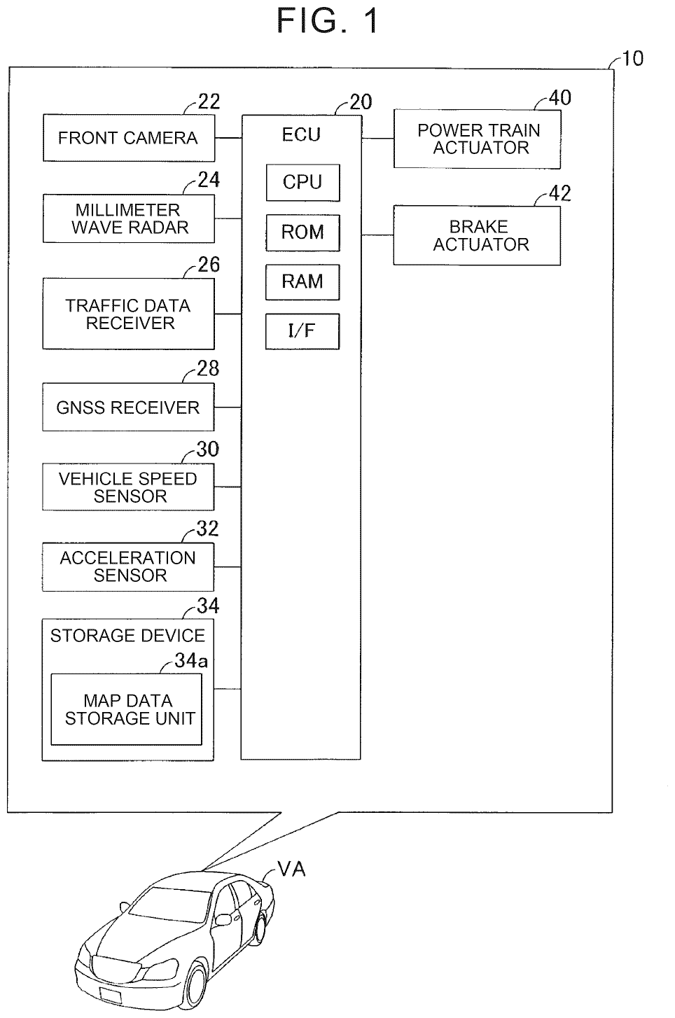

The driving assistance device 10 (hereinafter referred to as “device 10”) according to the embodiment of the present disclosure is applied to a vehicle VA and includes the components illustrated in FIG. 1. In the present specification, “ECU 20” is an electronic control device including a microcomputer as a main part. The ECU 20 are also referred to as a control unit, a controller, and a computer. The microcomputer includes a CPU (processor), a ROM, a RAM, and an interface (I/F). The function realized by the ECU 20 may be realized by a plurality of ECUs.

The front camera 22 captures an image of a scene in front of the vehicle VA. The millimeter wave radar 24 receives a reflected wave reflected by an object by a millimeter wave transmitted in front of the vehicle VA, and acquires radar data. The radar data is data relating to the position of the object with respect to the vehicle VA and the relative velocity of the object with respect to the vehicle VA. The ECU 20 acquires image data from the front camera 22 and acquires radar data from the millimeter wave radar 24. The ECU 20 recognizes objects in front of the vehicle VA based on the imaging data and the radar data.

The traffic data receiver 26 receives traffic data. The traffic data is data relating to a location where a traffic congestion has occurred and a location where a “traffic congestion-causing event that causes the traffic congestion” has occurred. For example, the traffic congestion-causing event is an accident or a “lane closure due to construction work etc.” For example, the traffic data may be VICS (registered trademark) data.

A GNSS (Global Navigation Satellite System) receiver 28 receives signals from a plurality of satellites and identifies the current location (latitude and longitude) of the vehicle VA based on the received signals. The ECU 20 obtains traffic data from the traffic data receiver 26 and obtains the current location of the vehicle VA from GNSS receiver 28.

The vehicle speed sensor 30 measures a vehicle speed Vs representing the speed of the vehicle VA. An acceleration sensor 32 measures longitudinal acceleration G of the vehicle VA. When the vehicle VA decelerates, the acceleration G becomes negative. The deceleration Gd of the vehicle VA is negative acceleration G. The deceleration Gd is represented by a positive value, and as the deceleration Gd increases, the deceleration of the vehicle VA becomes stronger. The vehicle speed sensor 30 measures a vehicle speed Vs representing the speed of the vehicle VA. The storage device 34 includes a map data storage unit 34a. The map data storage unit 42a stores map data related to the vehicle speed limit Vlmt of the roadway.

The powertrain actuator 40 changes a driving force generated by a driving device (for example, an internal combustion engine and/or an electric motor) of the vehicle VA. The brake actuator 42 changes the braking force applied to the vehicle VA.

### Deceleration Control

The ECU 20 of the device 10 executes deceleration control for automatically decelerating the vehicle VA with respect to an object in the direction of travel of the vehicle VA. In the deceleration control, a braking force is automatically applied to the vehicle VA regardless of an operation of a brake pedal (not shown) by the driver. The ECU 20 performs the deceleration control such that the deceleration-related value, which changes according to the start timing of the deceleration control and the deceleration of the vehicle VA, satisfies restriction conditions. The deceleration-related values are the deceleration Gd and jerk J of the vehicle VA. The jerk J is the time derivative of the deceleration Gd (i.e., the slope of the deceleration Gd).

When TTC (Time To Collision) of the object that is present in the direction of travel of the vehicle VA becomes less than or equal to the threshold time, the ECU 20 determines that the start timing has come, and starts the deceleration control. TTC represents the time it takes for the vehicle VA to collide with an object. The ECU 20 performs deceleration control so that the deceleration Gd and the jerk J do not exceed the upper limit deceleration Glmt and the upper limit jerk Jlmt, respectively. The upper limit deceleration Glmt is an upper limit value of the deceleration Gd in the deceleration control, and the upper limit jerk Jlmt is an upper limit value of the jerk J in the deceleration control.

### Overview of Operation

The ECU 20 determines whether a specific condition that a traffic congestion or a traffic congestion-causing event has occurred within a predetermined threshold distance Dth from the vehicle VA in the direction of travel of the vehicle VA is satisfied.

When the specific condition is satisfied, the ECU 20 eases the restriction conditions than when the specific condition is not satisfied. Specifically, when the specific condition is satisfied, the ECU 20 advances the start timing of the deceleration control than when the specific condition is not satisfied. When the specific condition is satisfied, the ECU 20 increases the upper limit deceleration Glmt and the upper limit jerk Jlmt more than when the specific condition is not satisfied.

When the specific condition is satisfied, it is more likely that a traffic congestion has occurred in the direction of travel of the vehicle VA than when the specific condition is not satisfied. When a traffic congestion occurs, there is an increased possibility that a surrounding vehicle may show an unexpected behavior. According to the present embodiment, when the specific condition is satisfied, the restriction conditions are eased compared to when the specific condition is not satisfied. Therefore, it is possible to increase the possibility that the deceleration control can sufficiently decelerate the vehicle VA even if the surrounding vehicle shows an unexpected behavior. This reduces the possibility that the risk of collision between the surrounding vehicle and the vehicle VA may increase when the surrounding vehicle shows an unexpected behavior. When the specific condition is not satisfied, the deceleration control is executed so as to satisfy normal restriction conditions. Therefore, it is possible to improve the riding comfort of the occupant of the vehicle VA when the specific condition is not satisfied.

In the present embodiment, the ECU 20 is configured to be capable of performing ACC (Adaptive Cruise Control) deceleration control and PCS (Pre-Crash Safety) deceleration control. In ACC, the acceleration and deceleration of the vehicle VA are automatically controlled so as to keep the inter-vehicle distance or the inter-vehicle time between the preceding vehicle PV and the vehicle VA constant within a range in which the vehicle speed Vs does not exceed the set vehicle speed Vset.

When the TTC of the object located in the direction of travel of the vehicle VA becomes equal to or less than the threshold time Tacc while the ACC is being executed, the ECU 20 determines that the start timing of the restriction conditions for the ACC deceleration control has come, and starts the ACC deceleration control ACC deceleration control is executed so that the deceleration Gd does not become larger than the upper limit deceleration Gacc and the jerk J does not become larger than the upper limit jerk Jacc.

When the specific condition is not satisfied, the ECU 20 sets the threshold time Tacc, the upper limit deceleration Gacc, and the upper limit jerk Jacc to the normal threshold time Tnoacc, the normal upper limit deceleration Gnoacc, and the normal upper limit jerk Jnoacc, respectively. On the other hand, when the specific condition is satisfied, the ECU 20 sets the threshold time Tacc, the upper limit deceleration Gacc, and the upper limit jerk Jacc to the traffic congestion threshold time Ttjacc, the traffic congestion upper limit deceleration Gtjacc, and the traffic congestion upper limit jerk Jtjacc, respectively. The traffic congestion threshold time Ttjacc, the traffic congestion upper limit deceleration Gtjacc, and the traffic congestion upper limit jerk Jtjacc are greater than the normal threshold time Tnoacc, the normal upper limit deceleration Gnoacc, and the normal upper limit jerk Jnoacc, respectively.

When TTC is equal to or less than the “threshold time Tpcs set to a value smaller than the threshold time Tacc”, the ECU 20 determines that the start timing of the restriction conditions for the PCS deceleration control has come, and starts the PCS deceleration control. PCS deceleration control is executed so that the deceleration Gd does not become larger than the upper limit deceleration Gpcs and the jerk J does not become larger than the upper limit jerk Jpcs.

When the specific condition is not satisfied, the ECU 20 sets the threshold time Tpcs, the upper limit deceleration Gpcs, and the upper limit jerk Jpcs to the normal threshold time Tnopcs, the normal upper limit deceleration Gnopcs, and the normal upper limit jerk Jnopcs, respectively. On the other hand, when the specific condition is satisfied, the ECU 20 sets the threshold time Tpcs, the upper limit deceleration Gpcs, and the upper limit jerk Jpcs to the traffic congestion threshold time Ttjpcs, the traffic congestion upper limit deceleration Gtjpcs, and the traffic congestion upper limit jerk Jtjpcs, respectively. The normal threshold time Ttjpcs, the normal upper limit deceleration Gtjpcs, and the normal upper limit jerk Jtjpcs are greater than the normal threshold time Ttjpcs, the normal upper limit deceleration Gtjpcs, and the normal upper limit jerk Jtjpcs, respectively.

Further, the threshold time Tpcs is smaller than the threshold time Tacc, and the upper limit deceleration Gpcs and the upper limit jerk Jpcs are larger than the upper limit deceleration Gacc and the upper limit jerk Jacc, respectively. Therefore, the PCS deceleration control is started later than the ACC deceleration control, and deceleration of the vehicle VA becomes stronger than in the ACC deceleration control.

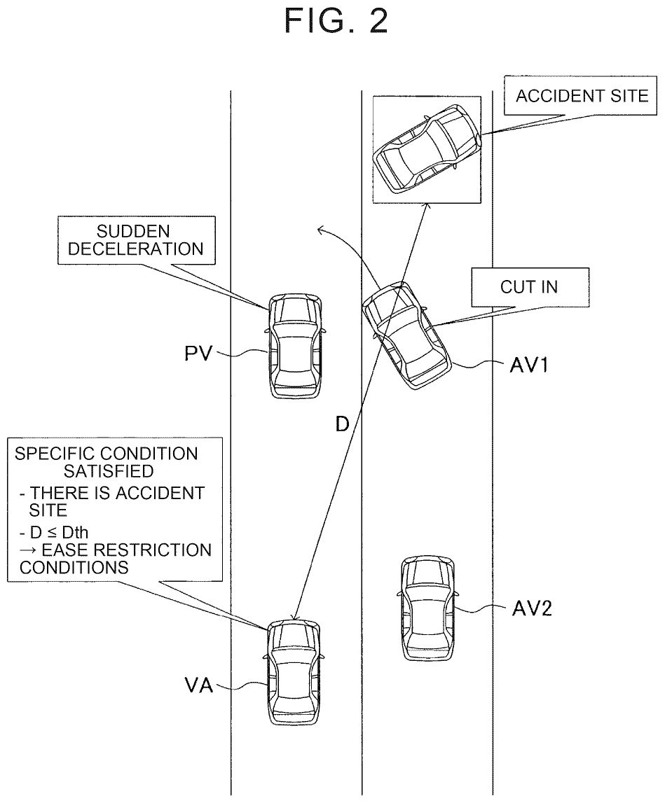

An operation example of the device 10 will be described with reference to FIG. 2. The ECU 20 determines that an accident has occurred in the direction of travel of the vehicle VA based on the traffic data. The accident is a traffic congestion-causing event. The ECU 20 obtains a distance D between the location where the accident occurred and the present location of the vehicle VA, and determines whether the distance D is less than or equal to the threshold distance Dth. When the distance D is equal to or smaller than the threshold distance Dth, the ECU 20 determines that the specific condition is satisfied, and eases the restriction conditions.

In the embodiment shown in FIG. 2, after the restriction conditions are eased, an adjacent vehicle AV1 cuts in front of the preceding vehicle PV in order to avoid the accident site, and therefore, the preceding vehicle PV suddenly decelerates. In this case, the TTC of the preceding vehicle PV decreases, and the TTC of the preceding vehicle PV becomes equal to or less than the traffic congestion threshold time Ttjacc. The ECU 20 then starts ACC deceleration control. The ACC deceleration control is executed such that the deceleration Gd and the jerk J do not exceed the traffic congestion upper limit deceleration Gtjacc and the traffic congestion upper limit jerk Jtacc, respectively.

When an adjacent vehicle AV2 cuts in front of the vehicle VA, the TTC (Time To Collision) of the adjacent vehicle AV2 becomes smaller, and the TTC of the adjacent vehicle AV2 becomes equal to or less than the traffic congestion threshold time Ttjpcs. The ECU 20 then starts the PCS deceleration control. The PCS deceleration control is executed such that the deceleration Gd and the jerk J do not exceed the traffic congestion upper limit deceleration Gtjpcs and the traffic congestion upper limit jerk Jtpcs, respectively.

### Specific Operation

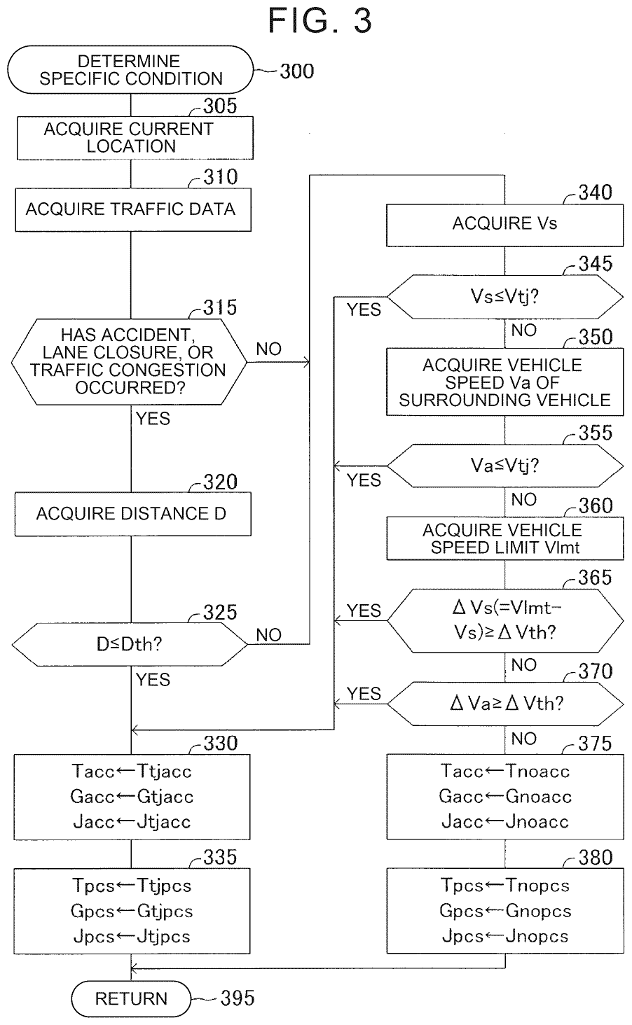

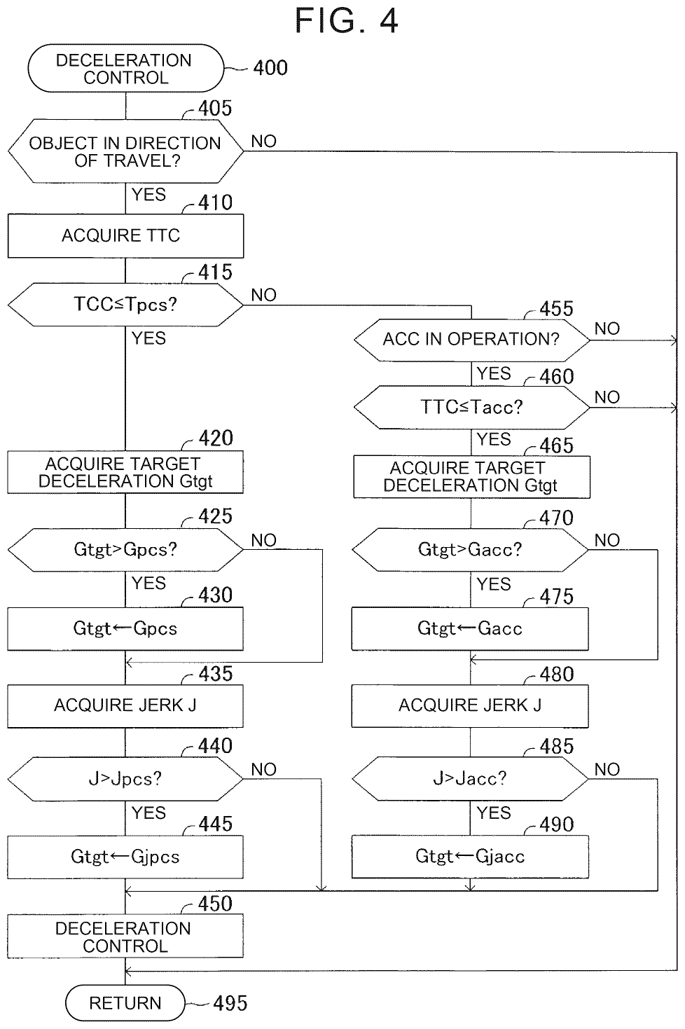

The CPU of the ECU 20 is executed every time a predetermined period elapses in the routines illustrated by the flow charts in FIGS. 3 and 4.

### Specific Condition Determination Routine

When the appropriate time has come, the CPU starts the process from step 300 of FIG. 3 and executes steps 305 to 315.
Step 305: The CPU obtains the current location of the vehicle VA from GNSS receiver 28.
Step 310: The CPU obtains traffic data from the traffic data receiver 26.
Step 315: The CPU determines whether an accident, a lane closure, or a traffic congestion has occurred within a predetermined range from the current location of the vehicle VA. For example, the CPU determines whether an accident, a lane closure, or a traffic congestion has occurred within a predetermined distance in the direction of travel of the vehicle VA in the own lane on which the vehicle VA is traveling and in a lane that is an adjoining lane adjoining the own lane and that is permitted to travel in the same direction as the own lane. The predetermined distance is a distance longer than a threshold distance Dth described later.

When an accident, a lane closure, or a traffic congestion has occurred, the CPU determines “Yes”in step 315 and performs step 320 and step 325.

Step 320: The CPU obtains the distance D between the event occurrence location and the current location of the vehicle VA. The event occurrence location is a location where an accident, a lane closure, or a traffic congestion has occurred. The CPU obtains an event location based on the traffic data.
Step 325: The CPU determines whether the distance D is equal to or less than the threshold distance Dth.

When the distance D is equal to or smaller than the threshold distance Dth (“Yes” in step 325), the CPU determines that the specific condition is satisfied. The CPU performs steps 330, 335.

Step 330: The CPU sets the threshold time Tacc, the upper limit deceleration Gacc, and the upper limit jerk Jacc to the traffic congestion threshold time Ttjacc, the traffic congestion upper limit deceleration Gtjacc, and the traffic congestion upper limit jerk Jtjacc, respectively.
Step 335: The CPU sets the threshold time Tpcs, the upper limit deceleration Gpcs, and the upper limit jerk Jpcs to the traffic congestion threshold time Ttjpcs, the traffic congestion upper limit deceleration Gtjpcs, and the traffic congestion upper limit jerk Jtjpcs, respectively.
   After that, the process proceeds to step 395, and the CPU ends the routine once.

When none of an accident, a lane closure, and a traffic congestion have occurred (“No” in step 315) and when the distance D is greater than the threshold distance Dth (“No” in step 325), the CPU performs steps 340 and 345.

Step 340: The CPU acquires the vehicle speed Vs.
Step 345: The CPU determines whether the vehicle speed Vs is equal to or less than the threshold vehicle speed Vtj. The threshold vehicle speed Vtj is set to a vehicle speed at which it can be estimated that a traffic congestion has occurred. For example, the threshold vehicle speed Vtj is set to “20 km/h”.

When the vehicle speed Vs is equal to or less than the threshold vehicle speed Vtj (“Yes” in step 345), the CPU determines that a traffic congestion has occurred and determines that the specific condition is satisfied. The process proceeds to step 330. When the vehicle speed Vs is greater than the threshold vehicle speed Vtj (“No” in step 345), the CPU performs steps 350 and 355.

Step 350: The CPU acquires the vehicle speed Va of a surrounding vehicle. Specifically, the CPU acquires the vehicle speed Va of the surrounding vehicle based on the relative speed and the vehicle speed Vs of the surrounding vehicle acquired based on the radar data. The vehicle speed Va of the surrounding vehicle may be referred to as “surrounding vehicle speed”. The CPU identifies, as surrounding vehicles, a preceding vehicle traveling in the host lane and an adjacent vehicle traveling in an adjacent lane in the same direction as the vehicle VA.
Step 355: The CPU determines whether the vehicle speed Va of the surrounding vehicle is equal to or less than the threshold vehicle speed Vtj.

When the vehicle speed Va of the surrounding vehicle is equal to or less than the threshold vehicle speed Vtj (“Yes” in step 355), the CPU determines that a traffic congestion has occurred and determines that the specific condition is satisfied. The process proceeds to step 330. When the vehicle speed Va of the surrounding vehicle is higher than the threshold vehicle speed Vtj (“No”in step 355), the CPU executes step 360 and step 365.

Step 360: The CPU acquires the vehicle speed limit Vlmt indicated by the road sign or the road sign based on the image data. In step 360, the vehicle speed limit Vlmt may be acquired by referring to the map at the current location of the vehicle VA.

Step 365: The CPU determines whether the first subtraction value ΔVs obtained by subtracting the vehicle speed Vs from the vehicle speed limit Vlmt is equal to or greater than the threshold ΔVth.

When the first subtraction value ΔVs is equal to or larger than the threshold ΔVth (“Yes” in step 365), the vehicle VA travels at a vehicle speed lower than the vehicle speed limit Vlmt. The CPU determines that a traffic congestion has occurred and determines that the specific condition is satisfied. The process proceeds to step 330. When the first subtraction value ΔVs is less than the threshold ΔVth (“No” in step 365), the process proceeds to step 370. In step 370, the CPU determines whether the second subtraction value ΔVa obtained by subtracting the vehicle speed Va of the surrounding vehicle from the vehicle speed limit Vlmt is equal to or greater than the threshold ΔVth.

When the second subtraction value ΔVa is equal to or larger than the threshold ΔVth (“Yes” in step 370), the surrounding vehicle travels at a vehicle speed lower than the vehicle speed limit Vlmt. In this case, the CPU determines that a traffic congestion has occurred, and determines that the specific condition is satisfied. The process proceeds to step 330. When the second subtraction value ΔVa is less than the threshold ΔVth (“No” in step 370), the specific condition is not satisfied. The CPU then performs steps 375, 380.

Step 375: The CPU sets the threshold time Tacc, the upper limit deceleration Gacc, and the upper limit jerk Jacc to the normal threshold time Tnoacc, the normal upper limit deceleration Gnoacc, and the normal upper limit jerk Jnoacc, respectively.
Step 380: The CPU sets the threshold time Tpcs, the upper limit deceleration Gpcs, and the upper limit jerk Jpcs to the normal threshold time Tnopcs, the normal upper limit deceleration Gnopcs, and the normal upper limit jerk Jnopcs, respectively.
   After that, the process proceeds to step 395, and the CPU ends the routine.

The determination as to whether the first subtraction value ΔVs or the second subtraction value ΔVa is equal to or greater than the threshold ΔVth is synonymous with the determination as to whether the vehicle speed Vs or the vehicle speed Va of the surrounding vehicle is equal to or greater than the “threshold obtained by subtracting the threshold ΔVth from the vehicle speed limit Vlmt”. That is, the thresholds compared with the vehicle speed Vs or the vehicle speed Va of the surrounding vehicle are changed based on the vehicle speed limit Vlmt. Whether the first subtraction value ΔVs or the second subtraction value ΔVa is equal to or larger than the threshold ΔVth is determined in step 365 or step 370.

### Deceleration Control Routine

Once the appropriate time has come, the CPU starts the process at step 400 of FIG. 4 and the process proceeds to step 405. At step 405, the CPU determines whether an “object that may collide with the vehicle VA” is present in the direction of travel of the vehicle VA based on the image data and the radar.

When the object is present in the direction of travel of the vehicle VA, the CPU determines “Yes”in step 405 and performs steps 410, 415.
Step 410: The CPU acquires the TTC of the object.
Step 415: The CPU determines whether the TTC is equal to or less than the threshold time Tpcs.

When TTC is equal to or less than the threshold time Tpcs (“Yes” in step 415), the CPU performs steps 420, 425.
Step 420: The CPU acquires target deceleration Gtgt for stopping the vehicle VA in front of the object.
Step 425: The CPU determines whether the target deceleration Gtgt is larger than the upper limit deceleration Gpcs.

When the target deceleration Gtgt is greater than the upper limit deceleration Gpcs (“Yes” in step 425), the process proceeds to step 430. In step 430, the CPU sets the target deceleration Gtgt to the upper limit deceleration Gpcs. Accordingly, the deceleration Gd does not become larger than the upper limit deceleration Gpcs. The CPU then performs steps 435 and 440.

Step 435: The CPU acquires the jerk J based on the current acceleration G and the target deceleration Gtgt.

Step 440: The CPU of steps determines whether the jerk J is greater than the upper limit jerk Jpcs.

When the jerk J is greater than the upper jerk Jpcs (“Yes” in step 440), the CPU performs steps 445, 450.
Step 445: The CPU sets the target deceleration Gtgt to such “deceleration Gjpcs that the jerk J does not exceed the upper limit jerk Jpcs”. Thus, the jerk J does not become larger than the upper limit jerk Jpcs.
Step 450: The CPU controls the powertrain actuator 40 and the brake actuator 42 so that the deceleration Gd of the vehicle VA coincides with the target deceleration Gtgt.

After that, the process proceeds to step 495, and the CPU ends the routine once.

When the target deceleration Gtgt is equal to or less than the upper limit deceleration Gpcs when the process proceeds to step 425 (“No” in step 425), the process proceeds to step 435. When the jerk J is less than or equal to the upper limit jerk Jacc when the process proceeds to step 440 (“No”in step 440), the process proceeds to step 450.

When the TCC is greater than the threshold time Tpcs when the process proceeds to step 415 (“No” in step 415), the process proceeds to step 455. In step 455, the CPU determines whether the ACC is in operation. When the ACC is in operation (“Yes” in step 455), the CPU determines whether the TTC is equal to or less than the threshold time Tacc in step 460. When TTC is equal to or less than the threshold time Tacc (“Yes” in step 460), then in step 465, the CPU acquires the target deceleration Gtgt for the vehicle VA to stop in front of the object.

In step 470, the CPU determines whether the target deceleration Gtgt is greater than the upper limit deceleration Gacc. When the target deceleration Gtgt is greater than the upper limit deceleration Gacc (“Yes” in step 470), the CPU sets the target deceleration Gtgt to the upper limit deceleration Gacc in step 475. At step 480, the CPU acquires the jerk J. In step 485, the CPU determines whether the jerk J is greater than the upper limit jerk Jacc.

When the jerk J is greater than the upper limit jerk Jacc (“Yes” in step 485), in step 490, the CPU sets the target deceleration Gtgt to such “deceleration Gjacc that the jerk J does not exceed the upper limit jerk Jacc”. The process then proceeds to step 450.

When the target deceleration Gtgt is equal to or less than the upper limit deceleration Gacc (“No” in step 470), the process proceeds to step 480. When the jerk J is less than or equal to the upper limit jerk Jacc (“No”in step 485), the process proceeds to step 450.

When the object is not present in the direction of travel (“No” in step 405), when the ACC is not in operation (“No” in step 455), and when the TTC is larger than the threshold time Tacc (“No” in step 460), the process proceeds to step 495. As a result, no deceleration control is performed.

As described above, when the specific condition is satisfied, the restriction conditions are eased compared to when where the specific condition is not satisfied. This reduces the possibility that the risk of collision may increase due to insufficient deceleration of the vehicle when the possibility that the surrounding vehicle may show an unexpected behavior increases.

The restriction conditions include a threshold time, an upper limit deceleration, and the upper limit jerk that define a start timing of the deceleration control. When the specific condition is satisfied, the device 10 eases the restriction conditions by setting each of the threshold time, the upper limit deceleration, and the upper limit jerk to a larger value than when the specific condition is not satisfied. As a result, the deceleration control is started earlier when the specific condition is satisfied than when the specific condition is not satisfied, and the vehicle VA can be decelerated strongly. Therefore, the possibility that the risk of collision may increase due to insufficient deceleration of the vehicle is reduced.

When the specific condition is satisfied, the device 10 may increase at least one of the threshold time, the upper limit deceleration, and the upper limit jerk more than when the specific condition is not satisfied.

In step 355 illustrated in FIG. 3, the CPU may determine that the specific condition is satisfied when the number of surrounding vehicles having the vehicle speed Va equal to or lower than the threshold vehicle speed Vtj is equal to or larger than the threshold number. In step 370, the CPU may determine that the specific condition is satisfied when the number of surrounding vehicles having the vehicle speed Va satisfying the condition that the second subtraction value ΔVa is equal to or greater than the threshold ΔVth is equal to or greater than the threshold.

Furthermore, it may be a prerequisite for the specific condition to be satisfied that the distance D between the event occurrence location and the vehicle VA is equal to or smaller than the threshold distance Dth and at least one of the conditions of steps 345, 355, 365, and 370 is satisfied.

In the above embodiment, the ECU 20 starts the deceleration control when TTC becomes equal to or less than the threshold time, but may determine that the start timing has come when the relative distance between the vehicle VA and the object becomes equal to or less than the threshold distance, and start the deceleration control. In this case, when the specific condition is satisfied, the threshold distance is longer than when the specific condition is not satisfied.

Therefore, when the relative relationship including at least the relative distance between the vehicle VA and the object satisfies the predetermined condition in the direction in which the relative distance is reduced, the ECU 20 may determine that the start timing has come and start the deceleration control. The relative relationship is the TTC or the relative distance. When the predetermined condition is satisfied, TTC ≤threshold time or relative distance ≤threshold distance is satisfied. When the specific condition is satisfied, the ECU 20 makes the relative relationship more likely to satisfy the predetermined condition than when the specific condition is not satisfied, thereby advancing the start timing of the deceleration control.

The device 10 is applicable to vehicles such as an engine driven vehicle, a hybrid electric vehicle, a plug-in-hybrid vehicle, a fuel cell electric vehicle, and a battery electric vehicle, and is also applicable to an autonomous vehicle.

What is claimed is:

1. A vehicle control device configured to execute deceleration control for automatically decelerating a vehicle for an object that is present in a direction of travel of the vehicle, wherein the vehicle control device is configured to
execute the deceleration control such that a start timing of the deceleration control and a deceleration-related value that changes due to the deceleration control satisfy a restriction condition, and
when a specific condition is satisfied, ease the restriction condition compared to when the specific condition is not satisfied, the specific condition being a condition that a traffic congestion or a traffic congestion-causing event has occurred within a predetermined distance from the vehicle in the direction of travel, the traffic congestion-causing event being an event that causes the traffic congestion.

2. The vehicle control device according to claim 1, wherein the vehicle control device is configured to
use, as the deceleration-related value, deceleration and jerk of the deceleration, and
when the specific condition is satisfied, ease the restriction condition by executing at least one of the following processes: a process of advancing the start timing compared to when the specific condition is not satisfied, a process of setting an upper limit of the deceleration to a larger value than when the specific condition is not satisfied, and a process of setting an upper limit of the jerk of the deceleration to a larger value than when the specific condition is not satisfied.

3. The vehicle control device according to claim 1, wherein the vehicle control device is configured to
when a relative relationship including a relative distance between the vehicle and the object satisfies a predetermined condition in a direction in which the relative distance decreases, determine that the start timing has come and start the deceleration control, and
when the specific condition is satisfied, advance the start timing compared to when the specific condition is not satisfied, by making the relative relationship more likely to satisfy the predetermined condition than when the specific condition is not satisfied.

4. The vehicle control device according to claim 1, wherein the vehicle control device is configured to, when an accident has occurred or a lane closure is in place within a predetermined distance from the vehicle in the direction of travel, determine that the traffic congestion-causing event has occurred and cause the specific condition to be satisfied.

5. The vehicle control device according to claim 1, wherein the vehicle control device is configured to
when a vehicle speed indicating a speed of the vehicle or a surrounding vehicle speed indicating a speed of a surrounding vehicle located around the vehicle is equal to or less than a threshold vehicle speed, determine that the traffic congestion has occurred and cause the specific condition to be satisfied, and
change the threshold vehicle speed based on a vehicle speed limit of a lane in which the vehicle is traveling.
